(19) United States
(12) Patent Application Publication
(10) Pub. No.: US 2013/0184163 A1
(43) Pub. Date: Jul. 18, 2013

(54) METHOD FOR IDENTIFYING COMPOUNDS

(71) Applicants: Guenther Ross, Freising (DE); Udo Ottmann, Mertingen (DE)

(72) Inventors: Guenther Ross, Freising (DE); Udo Ottmann, Mertingen (DE)

(73) Assignee: PRIAXON AG, Munich (DE)

(21) Appl. No.: 13/702,660

(22) PCT Filed: Jun. 7, 2011
(86) PCT No.: PCT/EP11/02783

§ 371 Date: Mar. 28, 2013

(30) Foreign Application Priority Data
Jun. 7, 2010 (EP) 10005857.7

(51) Int. Cl. C40B 20/00

(52) U.S. Cl. CPC C40B 20/00
USPC 506/2

(57) ABSTRACT

The present invention relates to a method for identifying compounds comprising the steps of: (a) providing a set of compounds; (b) optionally selecting a sub-set from the set of compounds based on one or more specific compound properties; (c) generating a 3D structure of each of the compounds provided and/or selected in step (a) or (b); (d) encoding each 3D structure; (e) providing at least one known compound having at least one desired property and/or providing a target molecule; (f) encoding the 3D structure of (each of) the known compound(s) provided in step (e) and/or the active site of the target molecule provided in step (e); (g) comparing said encoded 3D structure(s) of step (d) with the encoded 3D structure(s) of step (f); and (h) selecting all compounds falling within a specified similarity range.

In the drug discovery process the identification of new, active chemical entities is the key step to success. During the last two decades the application of “brute force” approaches such as high throughput screening has not yielded the desired results. In consequence smarter, more focused and less resource consuming technologies are required.

Once a target has been identified and passed the first stages of validation and investigation this knowledge base has to be used as efficiently as possible to discover and develop structural classes of compounds that show activity on the target and can be developed into clinical candidates and ultimately marketed drugs.

A rational approach to this task has to rest on two bases: The knowledge of chemical reactions and accessible structural classes that are innovative enough to allow room for development; and a technology that enables the straightforward identification of the right molecules and in consequence the right reactions for a given target. By now (May 5, 2010) 53,404,695 compounds have been registered in CAS (source: CAS homepage). Bearing in mind that many of these compounds have been published as examples for general chemical synthesis processes that could be applied to a much broader set of starting materials—consequently leading to a multitude of possible products—it is clear that astronomic numbers of accessible structures have to be processed and searched, even if obvious drug-likeness criteria are imposed. Only with powerful chemoinformatic tools this huge set of accessible structures can be searched efficiently.

The principal task of any computational search process is to reduce the billions of accessible structures to a final number that can be handled manually using human “Medchem intelligence” (some 100). This enables the selection, synthesis and biological testing of a reasonable and affordable number of compounds with a high probability of success. It is clear that the search algorithm and the molecular descriptors it uses to represent the compounds and their properties in silico is the crucial element of this process. An ideal balance between computing speed and accuracy has to be found to obtain high value computational hits within a reasonable time and cost frame.

The selection process can be broken down into three stages: In a first step the compounds are filtered for simple key data such as molecular weight, lipophilicity, polar surface area etc. which allow a rough indication specific classification. Still many millions of compounds are in the search set. In a second step, some hundreds of these millions are selected by different means for the third step, in silico docking. Finally the highest scoring compounds from step three are refined manually by molecular modeling to obtain candidates for synthesis and biological testing.

While step one is rather trivial and highly advanced software packages for docking and molecular modeling are available for step three, step two has a great potential for improvement. In this step most of the compounds are eliminated to achieve a reduction to numbers that can be handled reasonably in the laborious step three process. Consequently the method in step two needs to be fast enough to handle millions of compounds and accurate enough to select the most promising 0.1-0.01 percent of these for refinement.

During the last three decades the number of available 3D protein structures or protein/ligand complexes has grown rapidly. To be able to exploit this knowledge accurately there is a strong need for computational methods that rely on molecular descriptors encoding 3D structural information.

In contrast to the “data-explosion” in the field of chemical structure elucidation the number of available molecular 3D descriptors is poor, especially if compared to the great number of well defined 2D descriptors that rely on chemical connectivity only.

The situation gets even worse, when looking for a 3D descriptor that encodes the active binding site of a target protein and further, so far a complementary pair of molecular 3D descriptors that mirrors the geometric and chemical complementarity of a ligand/target interaction does not exist.

So the current state of chemoinformatics is far away from providing complete solutions that include molecular 3D information in the process of rational drug design.

This situation is typically caused by some general problems a designer of a molecular 3D descriptor is faced with. First, the processing of 3D information is by its very nature computationally more expensive than methods that only rely on connectivity, i.e. most of the computational code executed in 2D descriptor calculation can be implemented as fast integer operations whereas 3D descriptor calculation depends strongly on more time consuming floating point operations. Second, molecules in 3 dimensional space have an absolute position and orientation, but the 3D descriptor representation has to be independent of these coordinates. This is the so called “requirement of translational and rotational invariance”. Third, a molecular 3D descriptor should also allow to encode a “distribution of physico-chemical properties in space”, in other words: a pure geometric descriptor is a poor abstraction of a molecule, because a molecule is not just a set of points in space. And last, setting up a model that can describe the immanent complementarity of ligand/target interaction is not trivial. So the design of efficient and accurate molecular 3D descriptors is an art in itself.

The methods presented here address all these problems in an exact and flexible approach. Further, algorithms are described that are fast, robust and intuitive. Moreover they reflect the natural complementarity of a ligand molecule and the corresponding active site of a target protein. The methods are generally applicable to a broad range of potential targets and the search set of chemical structures is only limited by chemical and computational feasibility. Still there are fields in which their performance is exceptionally high. From the target side these are protein-protein interactions, which require a particularly precise description of complex 3D properties. From the side of the structural search space chemistries based on multicomponent reactions are especially attractive, because they allow the straightforward assembly of highly decorated (substituted) scaffolds that by now have only been poorly exploited in drug discovery efforts.

The present invention provides a method for identifying (or selecting) compounds (especially useful compounds). This method comprises the steps of:
(a) providing a set (space) of compounds;
(b) optionally selecting a sub-set (sub-space) from the set of compounds based on one or more specified compound properties;
(c) generating a 3D structure of (each of) the compounds provided and/or selected in step (a) or (b);
(d) encoding each 3D structure;
(e) providing at least one known compound having at least one desired property and/or providing a target molecule;
(f) encoding the 3D structure of each of the known compound(s) provided in step (e) and/or encoding the active site of the target molecule provided in step (e);
(g) comparing said encoded 3D structure(s) of step (d) with the encoded 3D structure(s) of step (f); and
(h) selecting all compounds falling within a specified similarity range.

Additionally, this method may further comprise the steps of:
(i) optionally selecting a further sub-set of the compounds provided in step (h) based on one or more specific compound properties;
(j) preparing the remaining (selected) compounds and testing the same;
(k) optionally repeating steps (g) to (j) or (h) to (j).

Preferably, steps (a) to (k) (as well as any further steps given herein) are carried out in the order given.

Preparing (or synthesizing) the compounds in step (j) may e.g. be performed manually in a laboratory (e.g. in a chemical laboratory by a chemist). As an alternative, the selected compounds of step (h) and/or (i) may be prepared automatically by a synthesizer for automated chemical synthesis.

Testing the compounds in step (j) may e.g. be performed manually in a laboratory (e.g. in a biological laboratory by a biologist). As an alternative, the testing may be carried out automatically, e.g. by a screening robot.

Testing (in step j) is preferably carried out in vitro.

Especially preferably, the present invention also relates to a method for screening for identifying compounds comprising the above mentioned steps (a) to (k).

Further preferably the present invention also relates to a method for synthesizing compounds comprising the above mentioned steps (a) to (k).

In step (e), also a set of known compounds each having at least one desired property may be provided instead of the at least one compound.

The compound(s) provided in step (e) is/are preferably provided in a 3D form.

In step (a) of the method for identifying useful compounds of the present invention, a set of compounds is provided. Basically a compound of this set of compounds can be any known compound or hypothetical compound. The hypothetical compound(s) is/are only limited by the possibility of their synthesis by known chemical reactions and/or reaction sequences and known educts for these reactions and/or reaction sequences. As already mentioned above, by now 53,404,695 known compounds have been registered in CAS. Further, since many of these compounds have been published as examples for general chemical synthesis processes that could be applied to a much broader set of starting materials a multitude of possible (hypothetical, virtual) compounds can be produced. These known and possible compounds (furthermore simply called compounds) form the basis for the set of compounds which can be provided in step (a).

Preferably, the compounds comprise at least one cyclic scaffold, e.g. at least one aromatic or heteroaromatic ring and/or non-aromatic ring (carbocyclic or heterocyclic). Especially preferably, the compounds have at least one non-aromatic five, six or seven membered ring (carbocyclic or heterocyclic) as scaffolds. In case a ring (aromatic or non-aromatic) is heterocyclic, it is preferred that it contains 1, 2, 3 or 4 heteroatoms selected from O, N and S.

Preferably the compounds provided in step (a) are products of one or more multicomponent reaction(s) (MCRs).

Especially preferred are multicomponent reactions providing compounds with a characteristic, three dimensional arrangement(s) of substituents around a scaffold.

Further preferred are multicomponent reactions yielding one or more non-aromatic five, six or seven membered rings as scaffolds.

Multicomponent Reactions (MCRs) are convergent reactions, in which three or more starting materials react to form a product, where basically all or most of the atoms contribute to the newly formed product. In an MCR, a product is assembled according to a cascade of elementary chemical reactions. Thus, there is a network of reaction equilibria, which eventually result in an irreversible step yielding the product.

Multicomponent reactions are e.g. described in: I. Ugi, Pure Appl. Chem., Vol. 73, No. 1, pp. 187-191, 2001; A. Dömling and I. Ugi. Angew. Chem. 112, 3300 (2000); Angew. Chem. Int. Ed. Engl. 39, 3168 (2000); A. Dömling, Chemical Reviews 2006 106 (1), 17-89; C. Kalinski, Molecular Diversity (published online March 2010; http://www.springerlink.com/content/3585832278t0k513) and references cited therein.

Several hundreds of MCRs are currently known. Of these, especially those MCR products which offer characteristic (e.g. fixed) three dimensional arrangements of substituents around a scaffold are preferred. Thus, all MCRs or MCR based preparative sequences that yield one or more non-aromatic five, six or seven membered rings as scaffolds are especially preferred.

MCRs may be used to generate a set of compounds in silico. Substituents bound to these scaffolds may e.g. be or resemble amino acid residues and may contain one or more representatives of all general classes of residues (small/big, polar/lipophilic, rigid/flexible, aliphatic/aromatic, presence of H-bond donors/acceptors etc.).

In optional step (b), a sub-set may be selected from the set of compounds based on one or more specified molecule properties. Preferably in step (b) one compound property for selecting the sub-set is the molecular weight; especially a molecular weight of 300 to 800 Da. Further specified compound properties which may be used for the selection of step (b) are clogP, D&A count, lipophilicity, polar surface area, etc.

In addition, compounds containing residues which are known to be problematic in pharmaceuticals may be removed from the set of compounds. Examples for such groups are e.g. epoxides, Michael-acceptors, nitro groups, anilines and hydrazines.

In step (c) a 3D structure of each of the compounds provided and/or selected in step (a) or (b) is generated. This is preferably done by generating all possible isomers (e.g. cis/trans) of the compounds and a representative set of conformers (e.g. 10-100) for each compound. Preferably in step (c) the generation of the 3D structure is carried out by generating a representative ensemble of low energy conformers via molecular modeling. The method preferably utilized for step (c) is based on a modified Genetic Algorithm (GA) allowing for a fast exploration of conformational space and the associated energy defined by a molecular mechanics potential energy function (force field). GAs have proved to be the method of choice when large search spaces like the conformational space of flexible molecules have to be sampled efficiently [Judson, R. Genetic algorithms and their use in chemistry. Reviews in Computational Chemistry 1997, 10, 1-73]. The modified GA used to perform step (c) is implemented as a part of a proprietary software package.

In step (d) the 3D structures of the compounds are encoded. Preferably the encoding of the 3D structures comprises the following steps:
(d1) taking only non-hydrogen atoms of the compound into account;
(d2) determining the center of mass of the compound;
(d3) determining the relative position of each non-hydrogen atom with respect to the center of mass;
(d4) determining the non-hydrogen atom farthest away from the center of mass and defining a vector sⱼ pointing from the center of mass to said atom;
(d5) defining a spatial area SAⱼ around said vector sⱼ; preferably the spatial area is a conic spatial area around vector sⱼ, especially with sⱼ being the rotational axis and the center of mass being the top of the cone;
(d6) associating all non-hydrogen atoms falling within said spatial area SAⱼ with said vector sⱼ;
(d7) repeating steps (d4) to (d6) with the remaining non-hydrogen atoms until no further non-hydrogen atoms are left; and
(d8) assigning all hydrogen atoms to the non-hydrogen atoms of the compound.

In the following paragraphs the preferred encoding of the 3D structures of the compounds will be described in detail:

In the context of the present invention the term “DPSM Descriptor” (DPSM=Distorted Polyhedral Super Molecule) relates to the encoded 3D structure.

A molecular graph is defined by a set of atoms (nodes) and a set of bonds (edges), where N is the number of atoms and N_{b} is the number of bonds:

A={a_{1,} a₂, . . . a_{N}}

B={b_{1,} b₂, . . . b_{Nb}}

The atomic coordinates are given by:

$${\vec{r}}_{i} = ( \begin{matrix}{x}_{i} \\ {y}_{i} \\ {z}_{i}\end{matrix} ) i = 1 … N$$

The center of mass of a molecule is:

$$\vec{c} = ( \begin{matrix}{x}_{c} \\ {y}_{c} \\ {z}_{c}\end{matrix} ) = \frac{1}{{\sum }_{i = 1}^{N} {m}_{i}} ( \begin{matrix}{\sum }_{i = 1}^{N} {m}_{i} {x}_{i} \\ {\sum }_{i = 1}^{N} {m}_{i} {z}_{i} \\ {\sum }_{i = 1}^{N} {m}_{i} {z}_{i}\end{matrix} )$$

For calculating the DPSM representation only non-hydrogen atoms are taken into account.

In the first step the relative atomic positions \vec{uᵢ} with respect to the center of mass of the molecule are calculated. This already separates the 3 translational degrees of freedom from the descriptor representation.

$${\vec{u}}_{i} = ( \begin{matrix}{x}_{i} - {x}_{c} \\ {y}_{i} - {y}_{c} \\ {z}_{i} - {z}_{c}\end{matrix} ) i = 1 … N$$

This results in a set of vectors pointing from the center of mass to the individual atoms:

U={\vec{u₁}, \vec{u₂}, . . . , \vec{N_{N}}}.

The elementary step consists in reducing this set of vectors to a basic set of so-called “shape vectors” which will point into the principal directions of molecular extent. For this purpose first a part of the molecule consisting of a sub-set of atoms is defined:

Sⱼ={aᵢ₍ⱼ₎} j=1 . . . M

There is one atom in each sub-set Sⱼ={aᵢ₍ⱼ₎} which is denoted as “base atom” aᵢ₍ⱼ₎*. This is the atom with the greatest distance to the center of mass:

|\vec{u}ᵢ₍ⱼ₎*|>|\vec{u}ᵢ₍ⱼ₎|

The position vector of the base atom defines the shape vector of the molecular part:

\vec{s}ⱼ=\vec{u}ᵢ₍ⱼ₎* shape vector

σⱼ=|\vec{s}ⱼ| length of the shape vector

The initial shape vector is given by the atom farthest away from the center:

\vec{s₁}=\vec{u}ᵢ₍₁₎*

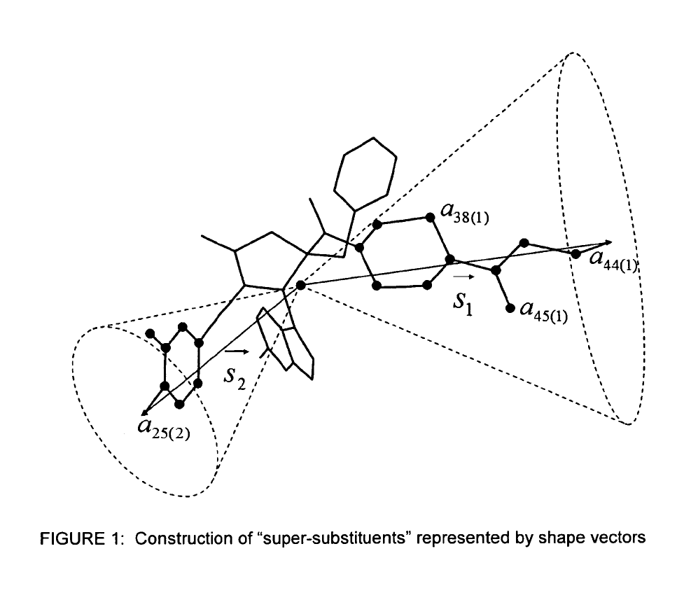

This shape vector defines the first principal direction of molecular extent. Then a conic spatial area is specified round \vec{s₁}, with \vec{s₁} being the rotational axis and the center of mass building the top of the cone. Each atom aᵢ₍₁₎ falling inside this spatial area is then associated with molecular part S₁ and its shape vector \vec{s₁} respectively (FIG. 1).

S₁={aᵢ₍₁₎}, \vec{s₁}

With the remaining set of atoms A₂=A₁−S₁ the procedure is repeated. Again the atom farthest away from the center now defines the second shape vector \vec{s₂} and all atoms falling inside the conic area are associated with S₂:

S₂={aᵢ₍₂₎}, \vec{s₂}

The procedure works in a recursive manner (Aᵢ₊₁=Aᵢ−Sᵢ) and an example for a corresponding algorithm is shown below. It terminates, when there are no further atoms left to process, i.e. all atoms are associated with a shape vector. Computational experiments have shown that for drug-like molecules the number of shape vectors typically ranges between 4 and 8.

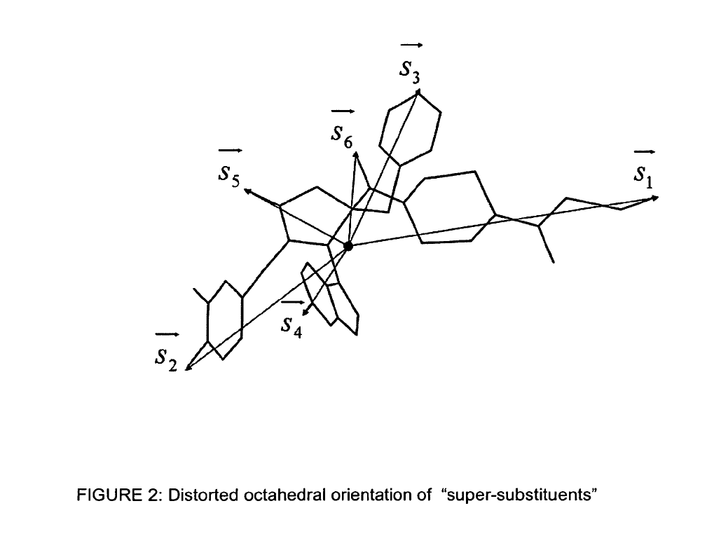

In this way molecular geometry is described as a kind of “super-molecule” consisting of a “central atom” (center of mass) and a set of “super-substituents” represented by the shape vectors and the atoms associated with them. The shape vectors point into the principal directions of spatial extent of the molecule and they typically describe a distorted polyhedral coordination sphere round the “central atom”. (FIG. 2: Distorted octahedral orientation of “super-substituents”)

One of the most important requirements a molecular descriptor should satisfy is the independency of its numerical representation from the size (number of atoms) of the molecule, because only then it is possible to compare different molecules based on their descriptor representation. To finally introduce uniqueness and rotational invariance, a static vector representation of the super-molecule is calculated:

The first vector coordinate stores the number of atoms:

g₁=N

The second coordinate is given by the number of shape vectors:

g₂=M

The third coordinate is defined by the sum of the lengths of all shape vectors:

$${g}_{3} = {\sum }_{k = 1}^{M} \vert \vec{{s}_{k}} \vert$$

The higher vector components are all calculated as triples of 3 statistical measures, i.e. the mean, the variance and the skewness of selected geometric or physical properties pₖ of the super-substituents:

$$\begin{matrix}{g}_{3} = \overline{p} = \frac{1}{M} {\sum }_{k = 1}^{M} {p}_{k} & Sample mean \\ {g}_{4} = σ = \frac{1}{M} {\sum }_{k = 1}^{M} {( {p}_{k} - \overline{p} )}^{2} & Sample variance \\ {g}_{5} = \frac{\frac{1}{M} {\sum }_{k = 1}^{M} {( {p}_{k} - \overline{p} )}^{3}}{{σ}^{3 / 2}} & Sample skewness\end{matrix}$$

When the lengths of the shape vectors are used as a geometric property, the mean gives a measure of the general size of the super-molecule, the variance describes how strong the super-substituents differ in spatial extent and the skewness characterizes the symmetry of the super-molecule.

However, when a physical property like the number of π-electrons associated with a super-substituent is used, these statistical measures provide information how this properties are distributed over the principal directions in space.

In one approach the lengths of the shape vectors, the approximate van der Waals volumes, the number of π-electrons and the number of branches associated with the super-substituents are used. Finally this leads to a vector representation of the molecule with a constant vector dimension (e.g. 15 in this case).

\vec{DPSM}=(g₁, g₂, g₃, . . . g_{3(P+1)}) dim(\vec{DPSM})=3(P+1)

P is the number of geometric and physical properties included.

When constructing the shape vectors additionally the condition that a super-substituent must represent a connected molecular graph (substructure) is imposed, i.e. each atom must be connected to at least one other atom of the super-substituent. This enables to include arbitrary physico-chemical properties that can be calculated for a conventional molecule, e.g. logP, number of H-bond donors/acceptors, Van der Waals Volume, Van der Waals Surface, Solvent Accessible Surface (SAS) to mention only a few.

To additionally include a specific measure of folding or puckering of the molecular shape also the ratio between solvent accessible surface and molecular volume should preferably be included:

$${p}_{j} = \frac{{SAS}_{j}}{{( {V}_{vdw} )}_{j}}$$

Pseudo code of the algorithm to construct a DPSM representation of a molecule:

| | |
|---|---|
| 0 - | take into account only non-hydrogen atoms A |
| 1 - | given the set of atoms A, search for the atom with greatest distance |
| | from the center |
| 2 - | make this atom the base atom aᵢ₍ⱼ₎*of Sⱼ |
| 3 - | define a spatial area SAⱼ around the shape vector \vec{s}ⱼ of Sⱼ |
| 4 - | associate with Sⱼ all those atoms aᵢ₍ⱼ₎ falling inside this spatial area |
| 5 - | with the remaining set of atoms Aⱼ₊₁ = Aⱼ − Sⱼ repeat the |
| | procedure starting at step 1 again |
| 6 - | GOTO 1 UNTIL all atoms are processed |

Preferably the active site of a target molecule is encoded by a method comprising the following steps:
(s1) taking only non-hydrogen atoms of the target molecule into account;
(s2) defining the center of the active site;
(s3) defining a sphere of radius R_{C} around this center;
(s4) determining all non-hydrogen atoms falling inside the sphere defined in (s3);
(s5) calculating the distance vector uⱼ between each atom determined in (s4) and the center of the active site;
(s6) defining a spatial area SUⱼ around each vector uⱼ;
(s8) calculating the reduction of volume of SUⱼ caused by intersecting atom spheres;
(s9) repeating steps (s5) to (s8) until no further non-hydrogen atoms are left;
(s10) creating a ranking of all uⱼ based on their effective volume; and
(s11) using the N best uⱼ as shape vectors for a comparison with the encoded 3D structures in step (g).

The basic idea behind the description of an active site of a target molecule via the DPSM concept is to encode geometric characteristics that are complementary to the DPSM representation of a compound. Whereas for the latter the basic algorithm shown above searches for principal directions of molecular extension in space, the procedure applied to an active site searches for principal directions of “ligand accessible space”. These regions of “empty space” may indicate the existence of pockets inside the active side which can be occupied by the corresponding residues of a potential ligand. Like in the case of the molecular DPSM descriptor the goal is to construct a set of shape vectors that define these principal directions in space. The basic strategy is again to define a center or reference point in space, but then to systematically “scan” the space around this center for regions of “empty space”.

Because the DPSM descriptor of the active site of a specific target is preferably calculated only once, there is no basic requirement to make the procedure incredible fast. From this point of view the construction of a set of DPSM shape vectors may also be carried out manually, e.g. by visually analysing the molecular surface of an active site via a molecular modeling tool and then to define a set of vectors pointing from the reference point into directions where the binding pockets are assumed to be located.

Nevertheless this simple approach is sometimes not adequate enough, especially if it comes to tasks like providing a whole set of possible DPSM descriptors for one active site, or if some DPSM descriptor based statistics of the active sites of target proteins stored in a database like the PDB (Protein Data Bank) must be performed.

A precondition for the algorithm presented below, is that at least an approximative location of the active binding site can be defined.

In the first step the center \vec{c} of the active site is defined. All atoms of the target protein falling inside a sphere of radius R_{C} around the center are assumed to represent the set of atoms A interacting with a potential ligand:

|\vec{r}ᵢ−\vec{c}|<R_{c} [symbol] ₐᵢ ∈ A

A={aₗ, aⱼ, . . . a_{N}} j=1 . . . N

Then, as in the case of the molecular DPSM, the relative atomic positions with respect to the center are calculated:

$$\vec{{u}_{j}} = ( \begin{matrix}{x}_{j} - {x}_{c} \\ {y}_{j} - {y}_{c} \\ {z}_{j} - {z}_{c}\end{matrix} ) j = 1 … N$$

$$U = \{ \vec{{u}_{1}} , \vec{{u}_{2}} , … \vec{{u}_{N}} \}$$

Again U is reduced to a basic set of shape vectors. First a spatial area SAⱼ is defined around each vector \vec{u}ⱼ. For reasons of mathematical simplicity a cylinder is prototypically used, whereas the vectors \vec{u}ⱼ define the rotational axis. The volume of a cylinder is:

Vⱼ=SAⱼ=rⱼ²π·|\vec{u}ⱼ|

rⱼ≈2.0

The volume will be reduced as soon as there is an atomic sphere aₖ intersecting with the cylinder. Because an intersecting atom aₖ (note: this is given by \vec{u}ₖ) represents a “spatial barricade” along direction \vec{u}ⱼ, the length of \vec{u}ⱼ is simply reduced instead of calculating the reduction of volume explicitly:

$${\vec{u}}_{j}^{\#} = \frac{1}{\vert {\vec{u}}_{j} \vert} \cdot {\vec{u}}_{j} \cdot \vert {\vec{u}}_{k} \vert \cdot cos [ ∠ ( {\vec{u}}_{j} , {\vec{u}}_{k} ) ]$$

So the shortened vector \vec{u}ⱼ^{#} points into the same direction as \vec{u}ⱼ does, but it indicates, that there is “empty space” along this direction until |\vec{u}ⱼ^{#}| is reached, where the atomic barrier is “located”. The reduced volume is therefore:

Vⱼ^{#}=rⱼ²π·|\vec{u}ⱼ^{#}|

Processing in this way all vectors \vec{u}ⱼ against all intersecting atoms aₖ and finally sorting the \vec{u}ⱼ^{#} according to their length (or volume) results in a set:

U^{#}={\vec{u₁^{#}}, \vec{u₂^{#}}, . . . , \vec{u_{N}^{#}}}

From this set, the first M vectors are selected to define the shape vectors \vec{s}ⱼ of the DPSM descriptor.

S={\vec{s₁}, \vec{s₂}. . . \vec{s_{M}}}={\vec{u₁^{#}}, \vec{u₂^{#}}, . . . \vec{u_{M}^{#}}}

Pseudo code of the algorithm to construct a DPSM representation of an active site:

```
  0 - only take into account non-hydrogen atoms
  1 - define the center C of the acive site
  2 - define a sphere of radius R_{C} around this center
  3 - define all atoms falling inside this sphere the set of active site
atoms A
  4 - FOREACH atom do
  5 - calculate the distance vector \vec{u}ⱼ = \vec{r}ⱼ − \vec{c} between the atom and the
center C
  6 - define a spatial area SAⱼ around \vec{u}ⱼ
  7 - calculate the reduction of volume of SAⱼ caused by intersecting
atom spheres
  8 - END FOREACH atom
  9 - create a ranking of all \vec{u}ⱼ based on their effective volume
10 - use the M best \vec{u}ⱼ as the shape vectors \vec{s}ⱼ of the DPSM descriptor
```

In this way a shape vector \vec{s}ⱼ of an active site DPSM descriptor represents a region of ligand accessible space (LAS) and may indicate a pocket that can be occupied by a super-substituent of a DPSM of a ligand molecule.

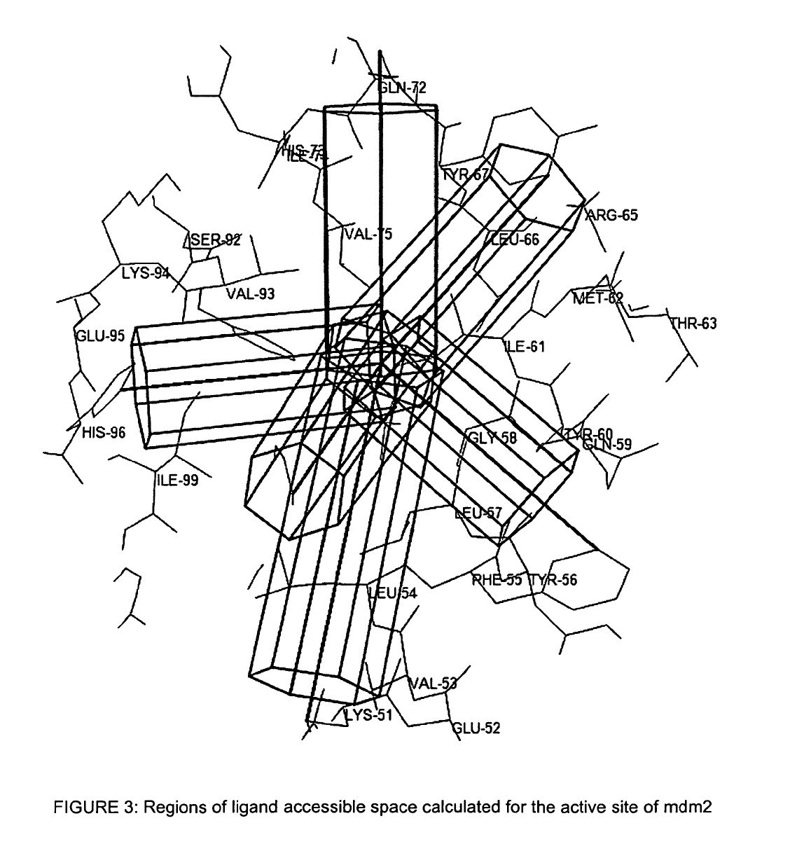

FIG. 3 shows regions of ligand accessible space calculated for the active site of mdm2.

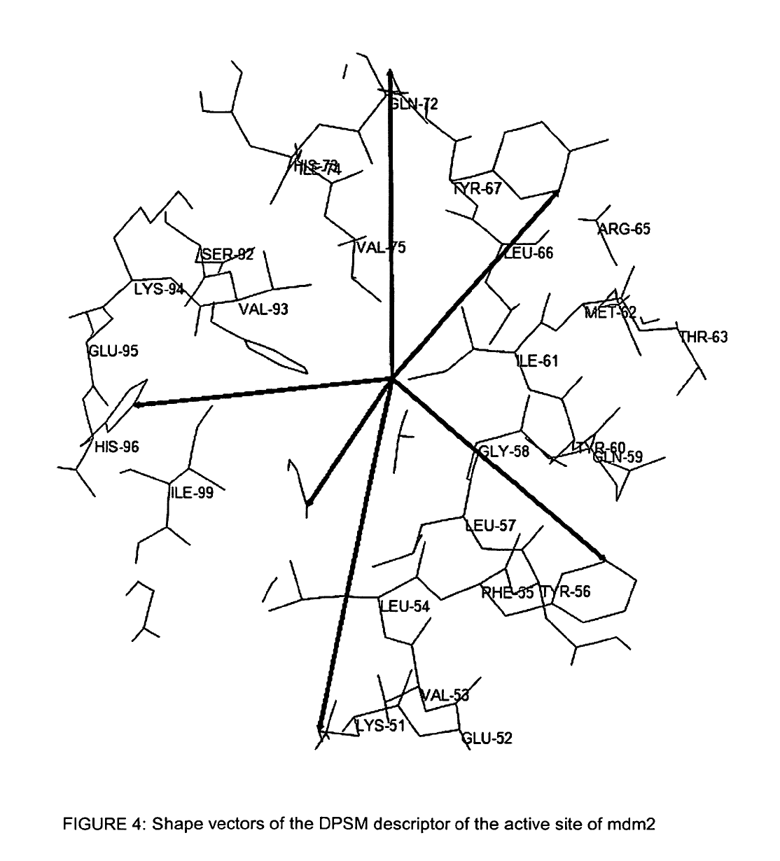

FIG. 4 shows shape vectors of the DPSM descriptor of the active site of mdm2.

Like in the case of the DPSM descriptor for compounds, several atoms of the active site can be associated with a shape vector \vec{s}ⱼ and so the physico-chemical properties of the pocket can be included into the descriptor.

To rationally handle Protein-protein-interactions (PPI) the knowledge about the binding site of a target protein is indispensable. Since this knowledge is not always available from scratch, the following fast and robust computational method has been developed that is able to identify potential binding sites as soon as 3D structural information of a target protein is available.

This method starts from the hypothesis that a binding site builds a kind of cavity that is more or less embedded into the molecular surface of a protein. Such a cavity is characterized by two major spatial regions. First there is an outer shell occupied by atoms of the target protein that constitute the molecular surface inside the cavity. Second there is an inner region that provides enough space for a ligand molecule to “reside” inside the cavity. This lead to a simple model of a cavity and a method for calculating a probability score for a definite protein region to be an active site.

The basic strategy of the method for identifying the binding site of a target molecule is to systematically scan the space occupied by a target protein for potential cavities that may be more or less embedded in the molecular surface. Starting from the simple picture, that a perfectly embedded cave can be abstracted as a “closed” sphere, the less the cave is embedded the more “open” the sphere will be.

In the present method a cavity is described by two concentric spheres, where the inner sphere provides space for a potential ligand and the region between the inner and the outer sphere defines an area where the “surrounding” atoms of the active site are located. An inner radius rᵢₙₙₑᵣ of 4-6 angströms is used to approximate the size of a virtual ligand molecule. The radius of the outer sphere rₒᵤₜₑᵣ is calculated by adding to the inner radius 3 times the van der Waals radius of a carbon atom rₒᵤₜₑᵣ=rᵢₙₙₑᵣ+3r_{vdW}(C) which result in about 11-13 angströms.

The algorithm to predict potential active sites is a “brute force” systematic search. First a cuboid enclosing the protein is defined. Within this cuboid a cartesian grid with a distance of grid points Δx≈1.0 angstroms is created. Each grid point defines the center of a probe cavity. For each probe cavity the number of atoms falling inside the inner sphere Nᵢₙₙₑᵣ and the number of atoms falling inside the region between the inner and the outer sphere Nₒᵤₜₑᵣ of the probe cavity is determined. The score is calculated by:

$$s = \frac{{N}_{outer}}{1 + {N}_{inner}}$$

In this way the highest scores are produced by probe cavities that are well embedded into the protein (Nₒᵤₜₑᵣ>>0) but that miss atoms inside the inner ligand sphere Nᵢₙₙₑᵣ→0.

Pseudo code of the corresponding algorithm:

| | |
|---|---|
| 0 - | only take into account non-hydrogen atoms |
| 1 - | define a cuboid enclosing the target protein |
| 2 - | inside the cuboid generate a regular cartesian grid with a point |
| | distance of Δx ≈ 1.0 |
| 3 - | FOREACH grid point DO |
| 4 - | define 2 concentric spheres around the point with R_{Inner} ≈ 5.0 and |
| | R_{Outer} ≈ 12.0 |
| 5 - | calculate number of atoms N_{Inner} falling inside the inner sphere |
| 6 - | calculate number of atoms Nₒᵤₜₑᵣ falling inside the shell between |
| | the inner and outer sphere |
| 8 - | calculate a fitness-score according s = N_{Outer}/1 + N_{Inner} |
| 9 - | store this core if it occupies a rank within the M highest scores |
| | found so far |
| 10 - | END FOR EACH |
| 11 - | the M highest scores provide a list of potential cavities or active |
| | sites |

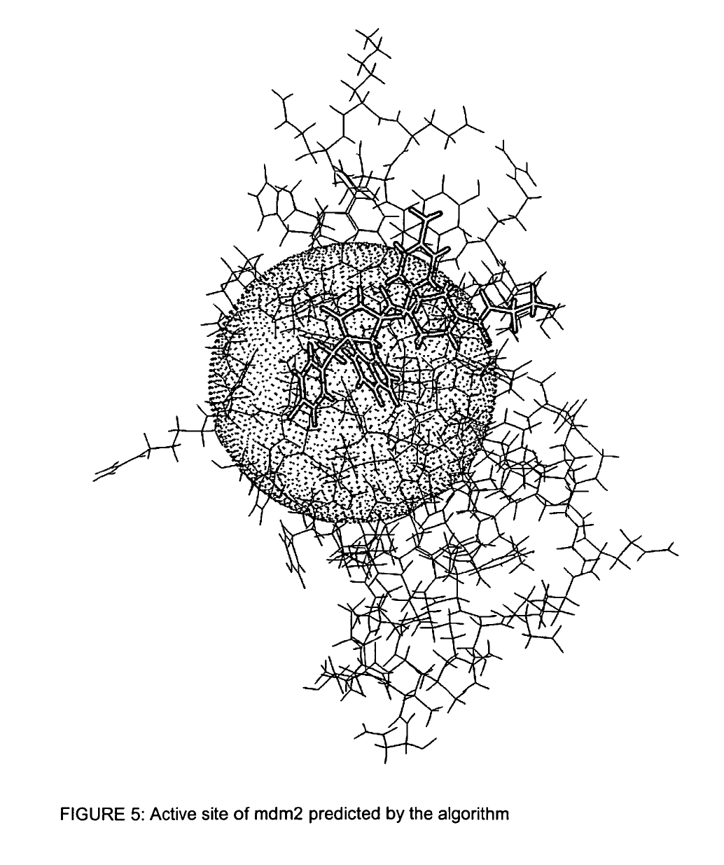

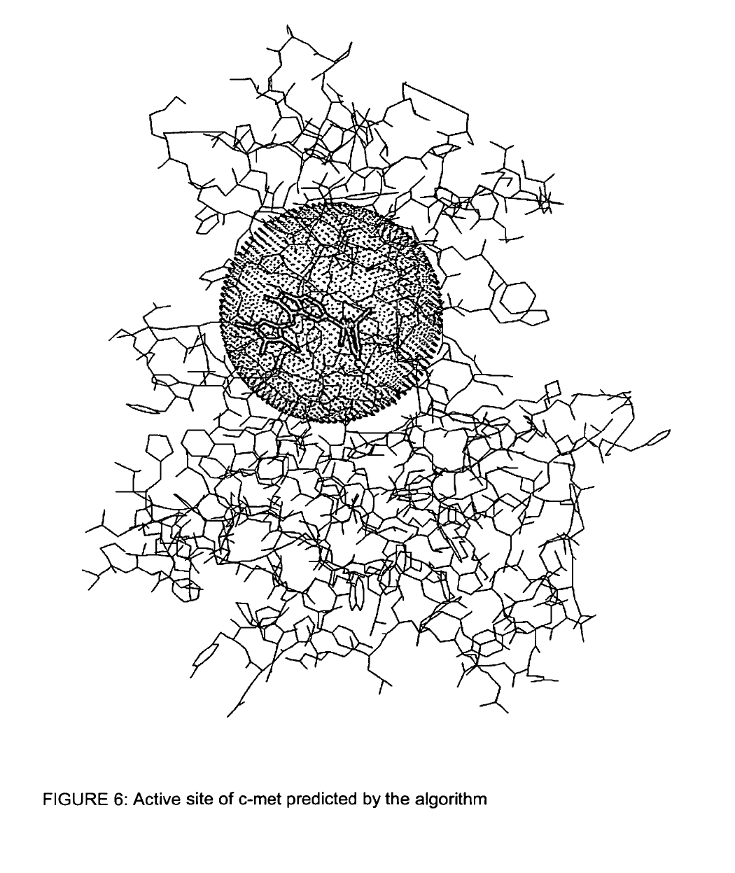

The images of FIGS. 5 and 6 show the co-crystal structures of mdm2/nutlin-3 and c-met/su1127 with the active sites predicted by this algorithm:

FIG. 5: Active site of mdm2 predicted by this algorithm

FIG. 6: Active site of c-met predicted by this algorithm

The similarity or distance of two molecular DPSM descriptors can simply be calculated on the basis of well-known metrics like the Euclidean or the Manhattan distance:

$$\begin{matrix}d ( {\vec{DPSM}}_{A} , {\vec{DPSM}}_{B} ) = \frac{1}{L} \sqrt{{\sum }_{j = 1}^{L} {( {g}_{j , A} - {g}_{j , B} )}^{2}} & Euclidean distance \\ d ( {\vec{DPSM}}_{A} , {\vec{DPSM}}_{B} ) = \frac{1}{L} {\sum }_{j = 1}^{L} ( {g}_{j , A} - {g}_{j , B} ) & Manhattan distance \\ L = dim ( {\vec{DPSM}}_{A} ) = dim ( {\vec{DPSM}}_{B} ) & \end{matrix}$$

As soon as structural information about a validated ligand or the active side of a target (or both) is available, it can be encoded via the corresponding DPSM descriptor and a 3D database of potential peptido-mimetics can be searched. The result of a similarity search is always a ranking based on the calculated distance measure and it provides a set of compounds that can further be processed in docking simulations and finally may lead to promising candidates for synthesis in the laboratory.

Preferably, in step (h) the similarity range is defined. Because of the difficulties in normalizing the concrete numeric values of the calculated distances, the similarity range is not defined explicitly. Instead of this a maximal number of ranks is used to limit the number of results of the similarity search.

Preferably, in optional step (i) the sub-set is selected on the basis of results of in silico docking. For the latter a GA based method is used, which is also implemented as a part of a proprietary software package. For each potential ligand molecule a small set of energetic minima of intermolecular ligand-target-interaction is searched. The energy of intermolecular interaction is assumed to provide an approximative measure of ligand-target-complementarity, i.e. a low energy conformation of a ligand molecule is assumed to define a possible binding mode.

MCRs provide an excellent spectrum of chemical scaffolds that can mimic the interacting amino acid residues of a native PPI ligand, because many of them constitute of a conformationally restrained central unit C (usually a small ring system) and a set of highly variable residues R1, R2 . . . R4 extending into different directions of space.

The method of the present invention can be applied in drug discovery projects under different starting conditions: If only ligands are known (scaffold hopping), for de novo generation of small molecule modulators starting from target information only, or ideally based on a combination of both.

Protein-protein-interactions (PPIs) are highly attractive targets for a variety of indications and could become successors of kinases as prime targets for a whole era. The method of the present invention is particularly suited for addressing PPIs, due to the following considerations:
PPIs employ binding motifs that contain three to four amino acids. An example is Mdm2, where Phe-Trp-Leu is known as binding triad (e.g. P. Chene, Molecular Cancer Research, Vol. 2, 20-28, Jan. 2004; S. Shangary, PNAS, Mar. 11 2008, Vol. 105, no. 10, 3933-3938). In nature there are 22 proteinogenic amino acids. This means that the number of possible sequence variations is limited: 22*22*22=10648.
The accessible diversity of binding motifs is multiplied by a rich number of conformations these sequences can take in proteins due to secondary and tertiary structures.
Multicomponent reactions (MCRs) are perfectly suited for the easy and straightforward assembly of three to four highly variable rests. A large number of MCRs deliver scaffolds that could be regarded as “peptide similar” in terms of spatial arrangement of substituents.

Literature PPIs as upcoming attractive target class: O. Sperandio, Drug Discovery Today, Volume 15, Numbers 5/6, March 2010; J. Fuller, Drug Discovery Today, Volume 14, Numbers 3/4, February 2009; J. Wells, NATURE, Vol 450, 13 Dec. 2007;

The term “useful” or “useful compounds” relates to compounds having desired properties. Preferably the compounds show a specific desired biological activity (e.g. the compounds may act as enzyme inhibitors). Especially preferably the compounds modulate (e.g. inhibit) protein-protein interactions.

According to a preferred embodiment, the present invention relates to a method for identifying compounds having a desired biological activity.

According to an especially preferred embodiment, the present invention relates to a method for identifying compounds that modulate (e.g. inhibit) protein-protein interactions.

The method of the present invention is preferably carried out in silico on a computing machine, e.g. on a computer. The results may e.g. be displayed on a display device (e.g. a monitor). Data may be fed to the computing machine by means of a keyboard and/or by means of a storage device, e.g. a harddisk.

Especially preferably, the method of the present invention is computer-implemented.

The method of the present invention especially provides the following advantages:

1. It provides for a drug discovery engine merging together several new concepts to approach the challenging field of identifying small ligand molecules e.g. for targets involved in protein-protein interactions (PPI). Current drug discovery engines are usually not capable in this area.

2. It uses novel molecular 3D descriptors emphasizing the principal directions of molecular extent in space. Current 3D descriptors mostly rely on viewing a molecule as a set of points in space and take into account interatomic distances only (J. Chem. Info. Comp. Sci. (1995), 35, 373-382).

3. It uses a novel active site 3D descriptor emphasizing the principal directions of space accessible for ligands. Current 3D descriptors mostly rely on a negative print of the active site and are computationally expensive to calculate.

### EXAMPLES

Ligand Based Similarity Search Using the DPSM Descriptor

To perform a validation of the DPSM descriptor implementation, first an appropriate search set of drug like molecules has been constructed.

The following sub-sets of three well known 3D structure databases were selected:

| | |
|---|---|
| ChemBank sub-set | 2,344 entries |
| ChemPDB sub-set | 4,009 entries |
| Drug-likeness NCl sub-set | 192,323 entries |

(The corresponding SDF-files are available at: http://ligand.info/).

These 3 sub-sets were merged into a single 3D structure database. Then the following filters were applied:
only use molecules consisting of atoms in the “organic sub-set”, i.e.
atom Type ∈ {H, B, C, N, O, F, P, S, Cl, Br, I}
only use molecules with a molecular weight m>100

This resulted in a set of 188128 compounds. To the latter the 3D structures of four validated mdm2-inhibitors have been added:

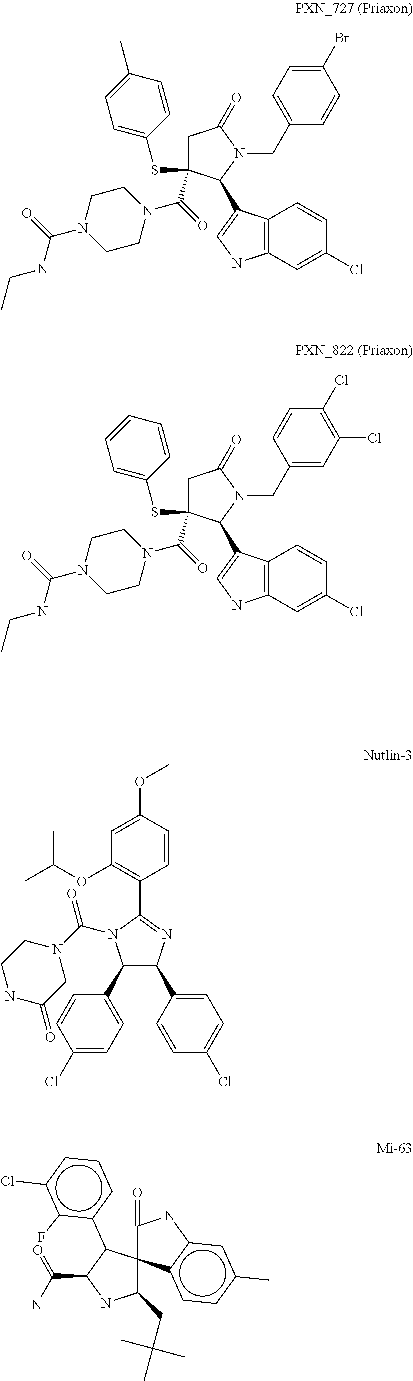

The final search set then encompasses 188133 molecular 3D structures. For searching this set, the following parameters were used:

a) Reference Structure: PXN_{—}727

b) Distance Metric: Manhattan Distance

c) Similarity-Descriptor: DPSM

d) DPSM-Parameters:

$$\begin{matrix}{g}_{1} = N & Number of atoms \\ {g}_{2} = M & Number of shape vectors \\ {g}_{3} = {\sum }_{j} {σ}_{j} & Sum of lengths of shape vectors \\ {g}_{4} , {g}_{5} , {g}_{6} & Lengths of shape vectors \\ {g}_{7} , {g}_{8} , {g}_{9} & Widths of shape {vectors}^{*} \\ {g}_{10} , {g}_{11} , {g}_{12} & Atomic van der Waals volumes \\ {g}_{13} , {g}_{14} , {g}_{15} & Number of π \text{-} electrons \\ {g}_{16} , {g}_{17} , {g}_{18} & Number of branches \\ {g}_{19} , {g}_{20} , {g}_{21} & Number of halogens \\ {g}_{22} , {g}_{23} , {g}_{24} & Number of chalcogens \\ {g}_{25} , {g}_{26} , {g}_{27} & Number of nitrogens\end{matrix}$$

* the “width” of a shape vector is calculated as the mean distance of the associated atoms from the line defined by the base vector

The 3D similarity search was carried out on a HP Intel 15 Quad Core machine. Because the current implementation did not support parallelism, only one of the CPU cores was used, which corresponds to only 25% of the overall CPU-power. Nevertheless searching the set of 188133 molecular structures needed only 16 seconds of computation time! This already demonstrates that DPSM is a quite fast computational method.

On the basis of the results obtained from other runs (with varying the DPSM parameters) the following conclusions could be drawn:
using geometric parameters only (lengths, volumes) usually leads to poor results
including chemical and topological parameters (π-electrons, branches etc.) dramatically improves the similarity rankings
including primary “1D filters” (number of atoms, sum of lengths of shape vectors) performs out molecules that show a similar distribution of properties in space but differ significantly in size from the query molecule

In the similarity search, all three other validated mdm2-inhibitors (PXN_{—}822, Nultin-3, Mi-63) are ranked within the first twenty molecules of highest similarity to reference structure PXN_{—}727.

PXN_{—}822 is most similar to PXN_{—}727 as can be seen easily from the formula. The structure of Nutlin-3 shows quite the same orientation of chemically similar substituents. The similarity between PXN_{—}727 and Mi-63 is not as obvious as for Nutlin-3 at the first glance, but this is one of the advantages of the DPSM descriptor—it does not take into account only geometric features like e.g. the USR molecular shape descriptor [P. J. Ballaster, W. G. Richards, Proc. R. Soc. (2007), 463, 1307-1321], but also includes physico-chemical properties, that must by nature be similar for the same class of inhibitor molecules.

1-9. (canceled)

10. A method for identifying compounds comprising the steps of:
(a) providing a set of compounds;
(b) optionally selecting a sub-set from the set of compounds based on one or more specific compound properties;
(c) generating a 3D structure of each of the compounds provided in step (a) or optionally selected in step (b);
(d) encoding each 3D structure;
(e) providing at least one known compound having at least one desired property or providing a target molecule;
(f) encoding a 3D structure of each known compound provided in step (e) or an active site of the target molecule provided in step (e);
(g) comparing each encoded 3D structure of step (d) with each encoded 3D structure of step (f); and
(h) selecting all compounds falling within a specified similarity range.

11. The method of claim 10, further comprising the steps of:
(i) optionally selecting a further sub-set of the compounds provided in step (h) based on one or more specific compound properties;
(j) preparing the selected compounds of step (h) or optionally selected compounds of step (i) and testing the prepared compounds for activity;
(k) optionally repeating steps (g) to (j) or (h) to (j).

12. The method of claim 10, wherein the compounds provided in step (a) are products of one or more multicomponent reactions.

13. The method of claim 12, wherein the one or more multicomponent reactions provide one or more products with a characteristic, three dimensional arrangement of substituents around a scaffold.

14. The method of claim 12, wherein the one or more multicomponent reactions yield a non-aromatic five, six or seven membered ring as scaffold.

15. The method of claim 10, wherein in step (b) the specific compound property for selecting the sub-set is a molecular weight of 300 to 800 Da.

16. The method of claim 10, wherein in step (c) the generation of the 3D structure is carried out by generating a representative ensemble of low energy conformers via molecular modeling.

17. The method of claim 10, wherein encoding of the 3D structures in step (d) comprises the steps of:
(i) taking only non-hydrogen atoms of the compound into account;
(ii) determining a center of mass of the compound;
(iii) determining a relative position of each non-hydrogen atom with respect to the center of mass;
(iv) determining the non-hydrogen atom farthest away from the center of mass and defining a vector Sⱼ pointing from the center of mass to said non-hydrogen atom;
(v) defining a spatial area SAⱼ around said vector Sⱼ;
(vi) associating all non-hydrogen atoms falling within said spatial area SAⱼ with said vector Sⱼ;
(vii) repeating steps (iv) to (vi) with the remaining non-hydrogen atoms until no further non-hydrogen atoms are left; and
(viii) assigning all hydrogen atoms to the non-hydrogen atoms of the compound.

18. The method of claim 10, wherein the active site of the target molecule in step (f) is encoded by a method comprising the steps of:
(i) taking only non-hydrogen atoms of the target molecule into account;
(ii) defining a center of the active site;
(iii) defining a sphere of radius R_{c} around the center of the active site;
(iv) determining all non-hydrogen atoms falling inside the sphere defined in (iii);
(v) calculating a distance vector uⱼ between each atom determined in (iv) and the center of the active site;
(vi) defining a spatial area SUⱼ around each vector uⱼ;
(vii) calculating a reduction of volume of SUⱼ caused by intersecting atom spheres;
(viii) repeating steps (v) to (vii) until no further non-hydrogen atoms are left;
(ix) creating a ranking of all uⱼ based on an effective volume; and
(x) using an N best uⱼ as shape vectors for a comparison with the encoded 3D structures in step (d).
